(19) United States
(12) Patent Application Publication
(10) Pub. No.: US 2026/0325965 A1
(43) Pub. Date: Oct. 22, 2026

(54) METHOD FOR INTERACTION PROCESSING METHOD IN GAME, AND ELECTRONIC DEVICE AND STORAGE MEDIUM

(71) Applicant: NETEASE (HANGZHOU) NETWORK CO., LTD., Hangzhou, Zhejiang (CN)

(72) Inventors: Zhangjun CHEN, Hangzhou, Zhejiang (CN); Zhentao ZHAO, Hangzhou, Zhejiang (CN)

(73) Assignee: NETEASE (HANGZHOU) NETWORK CO., LTD., Hangzhou, Zhejiang (CN)

(21) Appl. No.: 19/103,462

(22) PCT Filed: Mar. 1, 2023
(86) PCT No.: PCT/CN2023/079118

§ 371 Date: Feb. 12, 2025

(30) Foreign Application Priority Data
Aug. 16, 2022 (CN) 202210986090.0

(51) Int. Cl. A63F 13/533; A63F 13/822

(52) U.S. Cl. CPC A63F 13/533; A63F 13/822

(57) ABSTRACT

A method for interaction processing in a game, includes: receiving a trigger operation performed by a user on a target node, where the target node is a node in a target strategy tree in the game; determining a boot node of the target node in response to the trigger operation, and entering a first operation interface corresponding to the boot node; and, displaying a first trigger control for the boot node on the first operation interface, wherein the first trigger control is configured for performing a predetermined function for a virtual element corresponding to the boot node in the game.

### CROSS REFERENCE TO RELATED APPLICATIONS

The present application is a National Stage Application of International Application No. PCT/CN2023/079118 filed on Mar. 1, 2023 which is based upon and claims the priority of Chinese Patent Application No. 202210986090.0, entitled “Method for interaction processing, apparatus, electronic device, and storage medium” , filed on Aug. 16, 2022, and the content of both of which is incorporated here by reference in its entirety for all purposes.

### TECHNICAL FIELD

The present disclosure relates to the field of computer application technologies, and in particular, to a method for interaction processing in a game, an apparatus, an electronic device, and a storage medium.

### BACKGROUND

In a game, a tree structure is often used to represent certain gameplay mechanics, such as a technology tree, a talent tree, a weapon tree, a prop tree in a game, etc.

At present, when a player views a tree structure interface, all tree nodes will be displayed in the tree structure interface. When the player expects to perform an operation on each tree node, the player needs to find corresponding tree nodes first, and then open the tree nodes one by one to perform an operation each tree node, resulting in that the operation process of the player on each tree node becomes tedious and complex, and the processing efficiency is low.

### SUMMARY

In a first aspect, according to some embodiments of the present disclosure, there is provided a method for interaction processing in a game. The method includes: receiving a trigger operation performed by a user on a target node, where the target node is a node in a target strategy tree in the game; determining a boot node of the target node in response to the trigger operation, and entering a first operation interface corresponding to the boot node; and, displaying a first trigger control for the boot node on the first operation interface, where the first trigger control is configured for performing a predetermined function for a virtual element corresponding to the boot node in the game.

In a second aspect, according to an embodiment of the present disclosure, there is further provided an electronic device. The electronic device includes: a processor, a memory, and a bus, where the memory stores a machine-readable instruction executable by the processor; when the electronic device runs, the processor communicates with the memory through the bus; and when the machine-readable instruction is run by the processor, the steps of the method for interaction processing in a game in the first aspect or any one of the possible implementations of the first aspect are performed.

In a third aspect, according to an embodiment of the present disclosure, there is further provided a non-transitory computer-readable storage medium, where the computer-readable storage medium stores a computer program, and when the computer program is run by a processor, the steps of the method for interaction processing in a game in the first aspect or any one of the possible implementations of the first aspect are performed.

In order to make the above objectives, features and advantages of the present disclosure more obvious and understandable, the following detailed description is given with reference to the accompanying drawings by taking the preferred embodiments.

### BRIEF DESCRIPTION OF THE DRAWINGS

In order to more clearly illustrate the technical solutions of the embodiments of the present disclosure, the accompanying drawings required to be used in the embodiments are briefly described below. It should be understood that the following drawings show only certain embodiments of the present disclosure, and are therefore not to be considered as limitations on the scope. For those of ordinary skill in the art, other related drawings may be obtained according to these drawings without creative efforts.

FIG. 1 shows a flowchart of a method for interaction processing in a game provided according to some embodiments of the present disclosure;

FIG. 2 shows a flowchart of a step of entering a second operation interface provided according to some embodiments of the present disclosure;

FIG. 3 shows a flowchart of a step of determining a boot node of a target node provided according to some embodiments of the present disclosure;

FIG. 4 shows a schematic diagram of a traversal rule for a target strategy tree provided according to some embodiments of the present disclosure;

FIG. 5 shows a flowchart of a step of forming a boot order provided according to some embodiments of the present disclosure;

FIG. 6 shows a schematic diagram of determining a boot order provided according to some embodiments of the present disclosure;

FIG. 7 shows another schematic diagram of determining a boot order provided according to some embodiments of the present disclosure;

FIG. 8 shows another schematic diagram of determining a boot order provided according to some embodiments of the present disclosure;

FIG. 9 shows a flowchart of a step of displaying a first operation interface provided according to some embodiments of the present disclosure;

FIG. 10 shows a schematic diagram of a first operation interface provided according to some embodiments of the present disclosure;

FIG. 11 shows a flowchart of a step of triggering a boot node provided according to some embodiments of the present disclosure;

FIG. 12 shows a schematic structural diagram of an apparatus for interaction processing in a game provided according to some embodiments of the present disclosure;

FIG. 13 shows a schematic structural diagram of an electronic device provided according to some embodiments of the present disclosure.

### DETAILED DESCRIPTION

In order to make the objectives, technical solutions, and advantages of the embodiments of the present disclosure clearer, the technical solutions in the embodiments of the present disclosure will be clearly and completely described below with reference to the accompanying drawings in the embodiments of the present disclosure. It should be understood that the drawings in the present disclosure are for illustrative and descriptive purposes only, and are not intended to limit the protection scope of the present disclosure. In addition, it should be understood that the schematic drawings are not drawn to a physical scale. The flowchart used in the present disclosure illustrates operations implemented according to some embodiments of the present disclosure. It should be understood that the operations in the flowcharts may not be implemented in the order, and steps without logical context relationships may be performed in a reverse order or at the same time. In addition, under the guidance of the present disclosure, those skilled in the art may add one or more other operations to the flowchart, or may remove one or more operations from the flowchart.

The terms “a”, “an”, “the” and “said” are used in the specification to mean that there are one or more elements/components/or the like. The terms “include” and “have” are used to indicate an open inclusion and mean that there may be additional elements/components/or the like in addition to the listed elements/components/or the like. The terms “first” and “second” are only used as labels, rather than limitations on the number of objects.

It should be understood that, in the embodiments of the present disclosure, “at least one” means one or more, and “a plurality of” means two or more. “And/or” is merely an association relationship describing associated objects, indicating that there may be three relationships; for example, A and/or B may indicate three situations that A exists alone, A and B exist at the same time, and B exists alone. The character “/” generally indicates an “or” relationship between the objects associated before and after. “Comprising A, B, and/or C” refers to including any one or two or three of A, B, and C.

It should be understood that, in the embodiments of the present disclosure, “B corresponding to A”, “B being corresponded to A”, “A corresponds to B”, or “B corresponds to A”, indicates that B is associated with A, and B may be determined according to A. Determining B according to A does not mean that B is determined only according to A, and B may also be determined according to A and/or other information.

In addition, the described embodiments are merely some but not all of the embodiments of the present disclosure. Components of the embodiments of the present disclosure generally described and illustrated in the drawings here may be arranged and designed in a variety of different configurations. Therefore, the following detailed description of the embodiments of the present disclosure provided in the accompanying drawings is not intended to limit the scope of the present disclosure, but merely represents selected embodiments of the present disclosure. All other embodiments obtained by those skilled in the art based on the embodiments of the present disclosure without creative efforts shall fall within the protection scope of the present disclosure.

In a game, a gameplay is often displayed in the form of a tree structure, such as a science and technology tree, a talent tree, a weapon tree, a prop tree in a game, etc.

At present, when a player views a tree structure interface, all tree nodes will be displayed in the tree structure interface. When the player expects to perform an operation on each tree node, the player needs to find corresponding tree nodes first, and then open the tree nodes one by one to perform an operation each tree node, resulting in that the operation process of the player on each tree node becomes tedious and complex, and the processing efficiency is low.

In view of at least one aspect of the above problems, the present disclosure provides a method for interaction processing in a game, an apparatus, an electronic device, and a storage medium. By introducing an automatic boot mechanism, the operation process of the user on each node in a target strategy tree is simplified, thus improving the interaction efficiency.

First, the names involved in the embodiments of the present disclosure are briefly described.

In the embodiments of the present disclosure, a graphical user interface may be provided through a terminal device.

### Terminal Device.

The terminal device involved in the embodiments of the present disclosure mainly refers to a smart device for providing a game interface (presenting a game scene in a game interface) and performing a control operation on a virtual character. The terminal device may include, but is not limited to, any one of the following devices: a smartphone, a tablet computer, a portable computer, a desktop computer, a gaming machine, a personal digital assistant (PDA), an e-book reader, a moving picture experts group audio layer IV (MP4) player, or the like. An application that supports the game scene, such as an application that supports a three-dimensional game scene, is installed and run in the terminal device. The application may include, but is not limited to, any one of a virtual reality application, a three-dimensional map application, a military simulation application, a MOBA game, a multiplayer gunfight survival game, and a third-personal shooting (TPS) game. In some embodiments, the application may be an application in a stand-alone version, such as a 3D game application in a stand-alone version, or may be an application in a network online version.

### Graphical User Interface.

The graphical user interface is an interface display format by which a person communicates with a computer. The graphical user interface allows a user to manipulate an icon, an identifier, or a menu option on a screen by using an input device such as a mouse or a keyboard, and also allows the user to manipulate an icon or a menu option on the screen by performing a touch operation on a touch screen of a touch terminal, to select a command, start an application, or perform some other tasks, etc.

### Game Scene.

The game scene is a virtual scene displayed (or provided) when an application runs on a terminal or a server. In some embodiments, the virtual game is a simulated environment of a real world, or a semi-simulated and semi-fictional virtual environment, or a purely fictional virtual environment. The virtual scene is any one of a two-dimensional virtual scene and a three-dimensional virtual scene. The virtual environment may be the sky, the land, the ocean, or the like, where the land includes environmental elements such as a desert and a city. Among them, the game scene is a scene in which the user controls the complete game logic of the virtual character.

### Virtual Character.

The virtual character refers to a virtual character in the virtual environment. The virtual character may be a virtual character controlled by a player, including but not limited to at least one of a virtual avatar, a virtual animal, or an animation character. The virtual character may also be a virtual character not controlled by a player (i.e., a non-player character, NPC). In some embodiments, when the virtual environment is a three-dimensional virtual environment, the virtual character may be a three-dimensional virtual model; and, each virtual character has its own shape and volume in the three-dimensional virtual environment, and occupies a part of space in the three-dimensional virtual environment. In some embodiments, the virtual character is a three-dimensional character constructed based on a three-dimensional human skeleton technology, and the virtual character is implemented with different external images by wearing different skin. In some implementations, the virtual character may also be implemented by using a 2.5-dimensional or 2-dimensional model, which is not limited in the embodiments of the present disclosure.

There may be a plurality of virtual characters in the virtual scene, where the virtual character is a virtual character controlled by a player (i.e. a character controlled by a player through an input device), or artificial intelligence (AI) disposed in the virtual environment battle by training. In some embodiments, the virtual character is a virtual avatar for performing competition in a game scene. In some embodiments, a quantity of virtual characters in the game scene battle is preset, or is dynamically determined based on a quantity of terminal devices joining the virtual battle, which is not limited in the embodiments of the present disclosure. In some embodiments, the user can control the virtual character to move in the virtual scene, for example, can control the virtual character to run, jump, crawl, etc., and can also control the virtual character to battle with other virtual characters by using a virtual skill, a virtual prop, or the like provided by the application.

In some examples, the terminal device may be a local terminal device. Taking a game as an example, the local terminal device stores a game program and is configured to present a game screen. The local terminal device is configured to interact with the player through the graphical user interface, i.e., conventionally by downloading, installing and running the game program on the electronic device. The manner in which the local terminal device provides the graphical user interface to the player may include a plurality of manners; for example, the graphical user interface may be rendered and displayed on a display screen of the terminal device, or provided to the player by using a holographic projection. For example, the local terminal device may include a display screen and a processor. The display screen is configured to present the graphical user interface. The graphical user interface includes a game scene screen. The processor is configured to run the game, generate the graphical user interface, and control display of the graphical user interface on the display screen.

The application scene applicable to the present disclosure is described. The present disclosure may be applied to the technical field of games. In a game, a plurality of players participating in the game join the same virtual battle together.

Before entering the virtual battle, the player may select different character attributes, such as an identity attribute, for the virtual character of the player in the virtual battle to determine different camps by assigning different character attributes, so that the player wins the game match by performing the task assigned in the game at different battle stages of the current virtual battle. For example, the plurality of virtual characters having the character attribute A may obtain the winning of the game match by making the virtual character having the character attribute B to be “eliminated” in the battle stage. Here, the character attribute may also be randomly assigned to each virtual character participating in the current virtual battle when entering the virtual game.

The implementation environment provided by an embodiment of the present disclosure may include a first terminal device, a server, and a second terminal device. The first terminal device and the second terminal device respectively communicate with the server to implement data communication. In the embodiment, the first terminal device and the second terminal device are respectively installed with an application for performing the method for interaction processing in a game provided by the present disclosure, and the server is a server end for performing the method for interaction processing in a game provided by the present disclosure. Through the application, the first terminal device and the second terminal device may respectively communicate with the server.

Taking the first terminal device as an example, the first terminal device establishes communication with the server by running the application. In an optional implementation, the server establishes a virtual battle according to a game request of the application, where the parameters of the virtual battle may be determined according to parameters in the received game request. For example, the parameters of the virtual battle may include the quantity of characters participating in the virtual battle, the levels of characters participating in the virtual battle, or the like. When the first terminal device receives the response from the game server, the first terminal device displays the game scene corresponding to the virtual game through the graphical user interface of the first terminal device. The first terminal device is the device controlled by a first user, the virtual character displayed in the graphical user interface of the first terminal device is the player character controlled by the first user (i.e., a first virtual character), and the first user inputs an operation instruction through the graphical user interface to control the player character to perform a corresponding operation in the game scene.

Taking the second terminal device as an example, the second terminal device establishes communication with the server by running the application. In an optional implementation, the server establishes a virtual battle according to a game request of the application, where the parameters of the virtual battle may be determined according to parameters in the received game request. For example, the parameters of the virtual battle may include the quantity of characters participating in the virtual battle, the levels of characters participating in the virtual battle, or the like. When the second terminal device receives the response from the server, the second terminal device displays the game scene corresponding to the virtual game through the graphical user interface of the second terminal device. The second terminal device is a device controlled by a second user, the virtual character displayed in the graphical user interface of the second terminal device is the player character controlled by the second user (i.e., a second virtual character), and the second user inputs an operation instruction through the graphical user interface to control the player character to perform a corresponding operation in the virtual scene.

The server performs data calculation according to the game data reported by the first terminal device and the second terminal device, and synchronizes the calculated game data to the first terminal device and the second terminal device, so that the first terminal device and the second terminal device control the graphical user interface to render the corresponding game scene and/or virtual character according to the synchronized data issued by the game server.

In the embodiment, the first virtual character controlled by the first terminal device and the second virtual character controlled by the second terminal device are virtual characters in the same virtual battle. Among them, the first virtual character controlled by the first terminal device and the second virtual character controlled by the second terminal device may have the same character attribute, or may have different character attributes; and, the first virtual character controlled by the first terminal device and the second virtual character controlled by the second terminal device belong to the same camp.

It should be noted that in the virtual battle, two or more virtual characters may be included, and different virtual characters may respectively correspond to different terminal devices. That is, in the virtual battle, there are more than two terminal devices that respectively perform game data transmission and synchronization with the game server.

For ease of understanding the present disclosure, the method for interaction processing in a game, the apparatus, the electronic device, and the storage medium provided in the embodiments of the present disclosure are described below in detail.

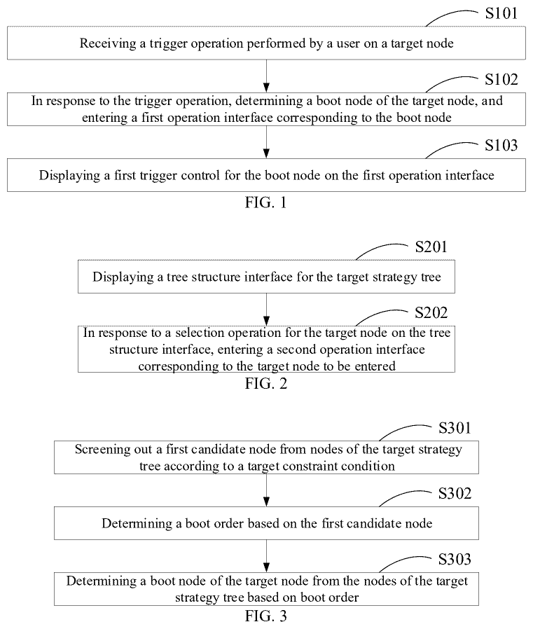

Referring to FIG. 1, FIG. 1 is a flowchart of a method for interaction processing in a game provided according to some embodiments of the present disclosure. The method for interaction processing specifically includes following steps.

In step S101, a trigger operation performed by a user on a target node is received.

Here, there is at least one strategy tree in the game, each strategy tree has at least one branch, and each branch has at least one node. The nodes having association relationships are connected by connecting lines. There may be a sequential relationship between two nodes connected by a connecting line, or there may be no sequential relationship between the two nodes connected by a connecting line.

For example, each node in the strategy tree corresponds to one virtual element in the game scene, and the state of the game world may be changed by performing an operation on the virtual element.

As an example, the strategy tree may include, but is not limited to, a science and technology tree, a talent tree, a weapon tree, a prop tree, a building tree (which may refer to a tree structure used to create a building in a game scene), or the like. That is, sciences and technologies, weapons, props, or the like in the game may be presented in the form of a tree structure. By performing an operation on the node in the tree structure, the virtual element corresponding to the operated node may be applied in the game scene to change the state of the game world.

In some embodiments of the present disclosure, it is allowed to enter the tree structure interface corresponding to the strategy tree in various manners to perform an operation on each node in the strategy tree.

In an example, a player in the game may obtain a game box in various manners. For example, the manner for obtaining the game box may include at least one of the following: paying for a virtual electronic resource, picking up and killing a virtual character of the enemy camp from the game scene, or completing a virtual task in the game. When an opening operation on the game box is received, a strategy tree corresponding to the game box is generated, and each node of the strategy tree is displayed on the tree structure interface. It should be understood that the listed manner of generating the strategy tree is merely an example, and the present disclosure is not limited to this.

In the embodiment of the present disclosure, the target node is a node in the target strategy tree in the game, and the target strategy tree is one of the at least one strategy tree present in the game.

As an example, the trigger operation is an operation for triggering a predetermined function corresponding to the target node. For example, the trigger operation may include a selection operation performed by the user on a second trigger control on a second operation interface corresponding to the target node. Here, the second operation interface is an interface for displaying description information of the target node and for performing an operation on the target node. The second trigger control is configured for performing a predetermined function for the virtual element corresponding to the target node in the game.

For example, each node in the strategy tree respectively corresponds to a virtual element in the game. Taking the target strategy tree being a building tree as an example, each node in the building tree corresponds to a building; and in this case, the second trigger control for the target node is configured for creating the building in the game scene. Taking the target strategy tree being a prop tree as an example, each node in the prop tree corresponds to a prop; and, the second trigger control for the target node is configured for enabling the virtual character to be equipped with the prop in the game.

For example, the virtual element may include a virtual item and a virtual skill for improving a battle capability of the virtual character. The virtual item may refer to a virtual prop in the game, and the virtual item is a virtual prop used to increase the virtual capability of the virtual character.

As an example, the virtual item may include, but is not limited to, at least one of the following: a virtual weapon held by the virtual character, a virtual accessory equipped on the virtual character or attached to the virtual weapon, where the virtual accessory may refer to an accessory that may be attached to the weapon, such as a gemstone, a gunstock, or the like.

The process of entering the second operation interface corresponding to the target node is described below with reference to FIG. 2. It should be understood that the manner shown in FIG. 2 is merely an example, and the present disclosure is not limited to this.

FIG. 2 shows a flowchart of the step of entering a second operation interface provided according to some embodiments of the present disclosure.

In step S201, a tree structure interface for the target strategy tree is displayed.

Here, the target node in the target strategy tree is displayed in the tree structure interface. For example, all nodes in the target strategy tree may be displayed in the tree structure interface to present the target node in the tree structure interface; or, an interface amplification operation may be performed on the tree structure interface, and only partial nodes including the target node in the target strategy tree may be displayed in the tree structure interface.

In step S202, a second operation interface corresponding to the target node is entered in response to a selection operation performed on the target node on the tree structure interface. In some embodiments of the present disclosure, the method for interaction processing may further include: determining whether the target node is the first triggered node after entering the tree structure interface. If it is determined that the target node is the first triggered node after entering the tree structure interface, the selection operation is a manual operation; for example, the selection operation is a click operation performed by the user on the target node. If it is determined that the target node is not the first triggered node after entering the tree structure interface, the selection operation is an automatic operation; for example, the selection operation is an operation of automatically selecting the target node after entering the tree structure interface.

In some embodiments of the present disclosure, the target node is a node in the target strategy tree that satisfies the following conditions: each node on the specified node path in the target strategy tree has been triggered, and the trigger condition corresponding to the target node belongs to a target constraint condition.

Here, the specified node path may refer to a path from the parent node of the target node to the root node, and the node being triggered refers to that a predetermined function has been performed on the virtual element corresponding to the node in the game. For example, the node being triggered refers to that the trigger control corresponding to each node has been selected. In the embodiments of the present disclosure, each node in the target strategy tree corresponds to a respective trigger condition. When the trigger condition is satisfied, a predetermined function is performed on the virtual element corresponding to the node in the game. When the trigger condition is not satisfied, a predetermined function is not performed on the virtual element corresponding to the node in the game.

The trigger condition corresponding to each node may be various constraint conditions triggered for the node. For example, the trigger condition corresponding to each node in the target strategy tree may include at least one of the following: a constraint condition for the trigger time, a constraint condition for the manufacturing material of the virtual element, or a task constraint condition for the virtual element (for example, associating a completion degree of at least one task in the game with a virtual element corresponding to the node).

When the trigger condition corresponding to the node is satisfied, it indicates that a predetermined function may be performed on the virtual element corresponding to the node in the game. Here, the trigger condition corresponding to the node further includes a condition that performing the predetermined function for the virtual element corresponding to the node is completed.

In the embodiments of the present disclosure, for the case that the trigger condition corresponding to the node is the constraint condition for the trigger time, the constraint condition for the trigger time corresponding to each node may include a first time constraint condition and a second time constraint condition. As an example, the first time constraint condition indicates that the trigger time corresponding to the node is 0, and the second time constraint condition indicates that the trigger time corresponding to the node is not 0. The trigger time may refer to a waiting time for triggering a predetermined function to be performed on the virtual element corresponding to the node. For example, for the node with the trigger time being 0, when the trigger control corresponding to the node is selected, a predetermined function is immediately performed on the virtual element corresponding to the node in the game; for the node with the trigger time being not 0, when the trigger control corresponding to the node is selected, the predetermined function is performed on the virtual element corresponding to the node in the game after the trigger time elapses.

Returning to FIG. 1, in step S102, in response to the trigger operation performed by the user on the target node, a boot node of the target node is determined, and a first operation interface corresponding to the boot node is entered.

In the embodiments of the present disclosure, a manner of entering the first operation interface corresponding to the boot node includes: automatically selecting the boot node to enter the first operation interface corresponding to the boot node.

Here, when the target node is triggered, an automatic boot mechanism is introduced to automatically select the boot node that needs to be operated without clicking by the user, which simplifies the operation process of the user for each node in the target strategy tree to a certain extent.

In a case, the boot node is a first candidate node in the target strategy tree. Here, the first candidate node is a node, the trigger condition of which belongs to the first time constraint condition, in the target strategy tree.

FIG. 3 shows a flowchart of a step of determining a boot node of a target node provided according to some embodiments of the present disclosure.

In step S301, a first candidate node is screened out from nodes of the target strategy tree according to a target constraint condition.

Here, the trigger condition corresponding to the node includes at least one constraint condition triggered for the node, the target constraint condition is one of the foregoing at least one constraint condition, and node screening may be performed on the target strategy tree based on the determined target constraint condition to obtain the first candidate node. As one of the example embodiments, the target constraint condition may be a first time constraint condition that the trigger time corresponding to the node is 0; or, the target constraint condition may be a first material constraint condition that the material loss value corresponding to the node is lower than a preset loss value; or, the target constraint condition may be a first task constraint condition that the task association degree of the node is greater than a second preset threshold. In other words, the first candidate node is a node that satisfies the target constraint condition in the target strategy tree.

In step S302, a boot order is determined based on the first candidate node.

Here, the boot order is a predetermined trigger order for each node in the target strategy tree. For example, the boot order is determined after each first candidate node in the target strategy tree is traversed, and is an order for automatically booting the user to perform function trigger on the node.

In the embodiment, the trigger order for the first candidate node is determined as the boot order for the target strategy tree. For example, the first sub-order of the first candidate node may be determined, and the first sub-order may be determined as the boot order.

For a case that the trigger condition corresponding to the node is a constraint condition for the trigger time, the target constraint condition includes a first time constraint condition.

In this case, the first sub-order for the first candidate node is determined in the following manner: determining a traversal order for the target strategy tree according to a preset traversal rule, and forming the first sub-order corresponding to all first candidate nodes by traversing each first candidate node in the target strategy tree according to the determined traversal order. Here, the first candidate node is a node, the trigger condition of which belongs to the first time constraint condition, in the target strategy tree.

Here, the predefined traversal rules can follow various traversal methods. For example, they may include, but are not limited to, pre-order traversal, in-order traversal, and post-order traversal of the target strategy tree, or the like. In addition, the preset traversal rules may also follow other customized traversal methods.

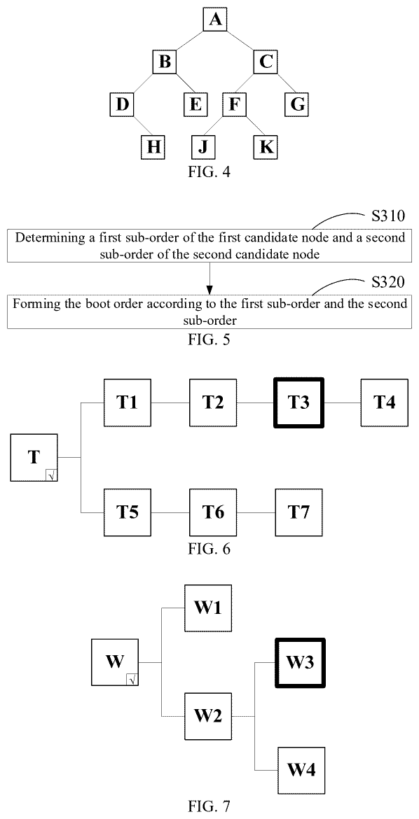

FIG. 4 shows a schematic diagram of a traversal rule for a target strategy tree provided according to some embodiments of the present disclosure.

In the example, a presented example of the target strategy tree is shown in the figure, and the target strategy tree includes 10 nodes from node A to node K.

The processes of determining the traversal order for the target strategy tree based on pre-order traversal, in-order traversal, and post-order traversal are respectively described below.

Taking pre-order traversal as an example, the traversal manner is that each node in the target strategy tree is traversed in an order of middle-left-right. The traversal order of the target strategy tree shown in FIG. 4 in this traversal manner is ABDHECFJKG.

Taking in-order traversal as an example, the traversal manner is that each node in the target strategy tree is traversed in an order of left-middle-right. The traversal order of the target strategy tree shown in FIG. 4 in this traversal manner is DHBEAJFKCG.

Taking post-order traversal as an example, the traversal manner is that each node in the target strategy tree is traversed in an order of left-right-middle. The traversal order of the target strategy tree shown in FIG. 4 in this traversal manner is HDEBJKEGCA.

According to the determined preset traversal manner, each candidate node in the target strategy tree may be traversed, in which omission is avoided.

In the embodiments of the present disclosure, the target strategy tree includes candidate nodes and non-candidate nodes, the candidate nodes are selectable nodes in the target strategy tree, and the non-candidate nodes are un-selectable nodes in the target strategy tree. For example, the node state of each node includes an unlocked state and a locked state, the node in the unlocked state is selectable, and the node in the locked state is un-selectable.

In the embodiments of the present disclosure, only the node in the unlocked state in the target strategy tree is determined as the candidate node for traversal.

Here, the candidate nodes include a first candidate node and a second candidate node. The first candidate node is a node, the trigger condition of which belongs to a first time constraint condition, in the target strategy tree. The second candidate node is a node, the trigger condition of which belongs to a second time constraint condition, in the target strategy tree.

In the embodiments of the present disclosure, traversal may be only performed on the first candidate node with the first time constraint condition to form the boot order.

In step S303, the boot node of the target node is determined from the nodes of the target strategy tree based on the boot order.

Here, the boot node is the next node to the target node in the boot order for the target strategy tree; that is, the node located at the next order position to the target node in the boot order is the boot node.

For example, when the target node has a node that is not at the last stage, the next boot node may be a node at the next stage of the target node. When the target node is the leaf node at the last stage of the branch A in the target strategy tree, the next boot node may start from the root node that returns to the branch B, that is, another root node is used as the next boot node.

In the embodiments of the present disclosure, the position of the first candidate node in the boot order is before other nodes.

According to the foregoing embodiments, the first candidate nodes are screened out from the target strategy tree, and boot is only performed on each first candidate node. Boot may not be performed on the second candidate node. In the embodiments, each first candidate node belonging to the first time constraint condition may be immediately triggered, and therefore, automatic boot is performed on this kind of nodes, which may facilitate subsequent operation of the user on the node, thus further improving the operation efficiency on the node and being conducive to improve the fluency of the game operation.

In another case, the boot node is a candidate node in the target strategy tree. Here, the candidate node serving as the boot node may be the first candidate node or the second candidate node. In the embodiments, the boot node is a next node to the target node in the boot order for the target strategy tree, that is, the node located at the next order position of the target node in the boot order is the boot node. Here, the boot order is a predetermined trigger order for each node in the target strategy tree. For example, the boot order is determined after each first candidate node in the target strategy tree is traversed, and is an order for automatically booting the user to perform function trigger on the node.

FIG. 5 shows a flowchart of a step of forming a boot order provided according to some embodiments of the present disclosure.

In step S310, a first sub-order of the first candidate node and a second sub-order of the second candidate node are determined.

Here, the manner in which the first sub-order of the first candidate node is determined is the same as the manner in which the first sub-order of the first candidate node is determined in step S302, which is not described in detail in the present disclosure.

For a case that the trigger condition corresponding to the node is a constraint condition for the trigger time, the constraint condition includes a second time constraint condition. In this case, traversal may be performed on each second candidate node in the target strategy tree according to the determined traversal order to form a second sub-order corresponding to all the second candidate nodes. Among them, the first sub-order and the second sub-order may be determined according to the same traversal rule, or may be determined according to different traversal rules, which are not limited in the example embodiment.

In step S320, the boot order is constructed according to the first sub-order and the second sub-order. Here, after traversal is performed on all selectable nodes in the target strategy tree, the boot order is formed.

For example, an arrangement order between the first sub-order and the second sub-order may be determined according to actual requirements.

In some embodiments, the arrangement order between the first sub-order and the second sub-order may be determined based on the historical operation habits.

In the embodiments of the present disclosure, the traversal manner for the candidate nodes is determined according to the historical operation data for each candidate node in the strategy tree in the game. For example, the historical operation data includes the operation order for each candidate node. For example, if it is determined to perform centralized processing respectively on each first candidate node and each second candidate node in the strategy tree (for example, after trigger of all first candidate nodes in the strategy tree is completed, trigger is then performed on all second candidate nodes) based on the historical operation data, it is determined to perform traversal respectively on each first candidate node and each second candidate node.

In the embodiments of the present disclosure, traversal is performed respectively on the candidate nodes with different trigger conditions, and the respective corresponding sub-order is determined to satisfy the personalized operation habits of the user.

For example, selection orders of different users for the first candidate node and the second candidate node in the game may be collected, and the arrangement order between the first sub-order and the second sub-order may be determined according to the selection orders. If it is determined based on the historical operation habits that the quantity of users that first select the first candidate node is greater than the quantity of the users that first select the second candidate node, it is determined that the first sub-order is before the second sub-order. If it is determined based on the historical operation habits that the quantity of users that first select the second candidate node is greater than the quantity of users that first select the first candidate node, it is determined that the first sub-order is after the second sub-order.

Here, based on the collected selection orders of different users for the first candidate node and the second candidate node in the game, when it is determined that the quantity of users that first select the first candidate node is greater than the quantity of the users that first select the second candidate node, the solution in which the boot order is determined only for the first candidate node may also be selected.

In addition, the historical operation habits of the current user (that is, the user performing the trigger operation in S101) may also be obtained, and the arrangement order between the first sub-order and the second sub-order may be determined according to the selection order of the user for the first candidate node and the second candidate node.

In some embodiments of the present disclosure, the second sub-order in the boot order is after the first sub-order, that is, the user is firstly booted to perform an operation on the first candidate node, and then the user is booted to perform an operation on the second candidate node, so that the operation habit of the user is considered while simplifying the operation process and improving the user operation experience, thus increasing the stickiness of the user.

The process of determining a boot order is described below with reference to the examples in FIG. 6 to FIG. 8.

FIG. 6 shows a first schematic diagram of determining a boot order provided according to some embodiments of the present disclosure.

In the example, it is assumed that the preset traversal rule is a traversal order from left to right and from top to bottom for the target strategy tree. In the target strategy tree shown in FIG. 6, the nodes T, T1, T2, T3, T5, T6, and T7 are candidate nodes, that is, the selectable nodes; and the node T4 is a non-candidate node, that is, an un-selectable node.

Specifically, the nodes T, T1, T2, T5, T6, and T7 are nodes, the trigger conditions of which belong to the first time constraint condition, in the target strategy tree. The node T3 is a node, the trigger condition of which belongs to the second time constraint condition, in the target strategy tree. Taking the target strategy tree being a prop tree as an example, the virtual element corresponding to the node belonging to the first time constraint condition may be a game object with a research time being 0 in the game, and the virtual element corresponding to the node belonging to the second time constraint condition may be a game object that needs a research time in the game, such as a ship technology value. The game object may include a game prop, a game skill, a virtual building, or the like.

In the present solution, traversal may be performed on the first candidate nodes T, T1, T2, T5, T6, and T7 according to the foregoing traversal order, to determine the first sub-order (T→T1→T2→T5→T6→T7). Traversal may be performed on the second candidate node T3 according to the foregoing traversal order, to determine the second sub-order (T3). The boot order formed by the first sub-order and the second sub-order is T→T1→T2→T5→T6→T7→T3.

After the trigger operation for the node T in the target strategy tree is received, the boot node of the node T is determined to be T1 according to the boot order. At this time, it is exited from the operation interface corresponding to the node T and returned to the tree structure interface; and the boot node T1 is automatically selected to enter the operation interface corresponding to the node T1.

After this, if the trigger operation for the node T1 is received, the above process is repeated; that is, the boot node of the node T1 is determined to be T2 according to the boot order. At this time, it is exited from the operation interface corresponding to the node T1 and returned to the tree structure interface; and the boot node T2 is automatically selected to enter the operation interface of the node T2.

By analogy according to this, the above process is repeated subsequently for the above nodes according to the order of T5→T6→T7→T3.

That is, after determining the boot order for the target strategy tree, subsequently, each node is automatically selected in sequence according to the boot order to boot the user to perform an operation on the selected node.

FIG. 7 shows a second schematic diagram of determining a boot order provided according to some embodiments of the present disclosure.

In the example, it is assumed that the preset traversal rule is still the traversal order from left to right and from top to bottom for the target strategy tree. In the target strategy tree shown in FIG. 7, the nodes W, W1, W2, W3, and W4 are candidate nodes. The nodes W, W1, W2, and W4 belong to the first candidate nodes, and the node W3 belongs to the second candidate node. In the present solution, traversal may be performed respectively on the first candidate nodes W, W1, W2, W4 and the second candidate node W3 according to the foregoing traversal order, and the formed boot order is W→W1→W2→W4→W3.

According to the foregoing boot order, the process of automatic selection and manual trigger is sequentially performed on each node.

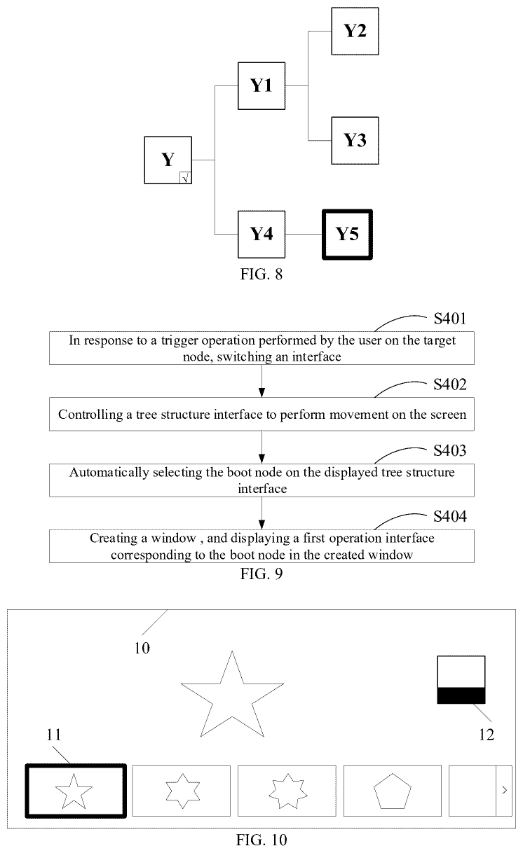

FIG. 8 shows a third schematic diagram of determining a boot order provided according to some embodiments of the present disclosure.

In the example, it is assumed that the preset traversal rule is still the traversal order from left to right and from top to bottom for the target strategy tree. In the target strategy tree shown in FIG. 8, the nodes Y, Y1, Y2, Y3, Y4, and Y5 are candidate nodes. The nodes Y, Y1, Y2, Y3, and Y4 belong to the first candidate nodes, and the node Y5 belongs to the second candidate node.

In the present solution, traversal may be performed respectively on the first candidate nodes Y, Y1, Y2, Y3, Y4, and the second candidate node Y5 according to the foregoing traversal order, and the formed boot order is Y→Y1→Y2→Y3→Y4→Y5.

According to the foregoing boot order, the process of automatic selection and manual trigger is sequentially performed on each node.

It should be understood that the foregoing traversal order may also be the parent node first and the child node later. That is, traversal is performed according to the order of a parent node-a child node and a parent node-a child node, which is not limited in the present disclosure or may be randomly determined.

In the embodiments of the present disclosure, the processing process shown in FIG. 1 may be performed for each node in the boot order one by one according to the boot order. That is, each node is sequentially taken as the target node to trigger an automatic selection mechanism for the boot node. Based on the above manner combining automatic boot and manual trigger, not only can the frequent operations of the user on each node be avoided, but also can the omission of the nodes in the target strategy tree be avoided.

In addition, based on the manner of automatic boot and manual trigger, the interaction experience that the user obtains the virtual element from the game is retained, while reducing the operation complexity of the user for each node, which are conducive to improve the stickiness of the user. In addition, the interaction experience breakpoint caused by frequent sliding and clicking of the user may be reduced, thus improving the play smoothness.

The process of entering the first operation interface corresponding to the boot node is described below with reference to FIG. 9. It should be understood that the processing shown in FIG. 9 is merely an example, and the present disclosure is not limited to this.

FIG. 9 shows a flowchart of a step of displaying a first operation interface provided according to some embodiments of the present disclosure.

In step S401, the interface is switched in response to a trigger operation performed by the user on the target node.

Here, the trigger operation may be a selection operation performed by the user on the second trigger control on the second operation interface corresponding to the target node. In this case, in response to the selection operation, it is exited from the second operation interface corresponding to the target node, and the tree structure interface is displayed, to switch the interface.

In step S402, the tree structure interface is controlled to perform movement on the screen to display the boot node in the target strategy tree on the screen.

Here, the tree structure interface may be displayed in the graphical user interface provided by the terminal device, and the tree structure interface may be controlled to slide relative to the screen of the terminal device, so as to present the boot node on the screen. It is due to the fact that, in order to facilitate the user to perform an operation on the node in the target strategy tree, the tree structure interface may be enlarged, resulting in that all nodes of the target strategy tree cannot be completely presented on the tree structure interface. At this time, after the operation is performed on a node, it is needed to move the tree structure interface to present another node on the screen.

In step S403, the boot node is automatically selected on the displayed tree structure interface. Here, the selection operation on the boot node is performed automatically, and the user does not need to manually perform a click operation on the boot node.

In step S404, a window is created, and a first operation interface corresponding to the boot node is displayed in the created window.

In an example, after the boot node is automatically selected, the first operation interface may be directly displayed in the graphical user interface.

In another example, after the boot node is automatically selected, the first operation interface may be displayed in the created window.

Preferably, the window may be displayed in a floating manner above the tree structure interface. When a movement operation performed by the user on the window is received, the display position of the window on the tree structure interface may be changed.

For example, the method for interaction processing in the embodiments of the present disclosure may further include: receiving a positioning operation performed on the window; determining, in response to the positioning operation, a positioning node corresponding to the window from the target strategy tree; if the positioning node belongs to the first candidate node, adjusting the sort of the positioning node in the boot order; and if the positioning node belongs to the second candidate node or the non-candidate node, not adjusting the boot order.

For example, a positioning control may be provided within the window or at the edge of the window. As an example, the positioning operation may include a selection operation on the positioning control of the window. In addition, the positioning node may refer to a node closest to the window in the target strategy tree, or may refer to a node covered by the area where the window is located.

As an example, the manner of adjusting the sort of the positioning node in the boot order may include determining the positioning node as a node located next to the boot node in the boot order.

Here, the above steps S401 to S404 are a series of actions performed after the trigger operation performed by the user on the target node is received, so as to realize automatic boot of the user. Returning to FIG. 1, in step S103, a first trigger control for the boot node is displayed on the first operation interface.

In the embodiments of the present disclosure, the first trigger control is configured for performing a predetermined function for the virtual element corresponding to the boot node in the game. For example, introduction information for the virtual element corresponding to the boot node may be further displayed in the first operation interface, so as to facilitate the user to confirm the virtual element.

Based on the foregoing interaction processing solution of the present disclosure, for the target node in the strategy tree, an automatic boot mechanism for the boot node of the target node may be triggered, so that frequent operations of the user on each node may be avoided, and the operation process is simplified, which are conducive to improve the operation fluency.

In a case, the boot node is a node, the trigger condition of which belongs to the first time constraint condition, in the target strategy tree.

In this case, the first operation interface is a simplified interface including the first trigger control for the boot node. That is, the virtual element corresponding to the boot node is unique, and the first operation interface may include the first trigger control for the boot node and introduction information for the corresponding virtual element.

In this case, in response to a selection operation on the first trigger control, a next node to the boot node in the boot order for the target strategy tree is determined, and a third operation interface corresponding to the node is entered.

Here, it is equivalent to taking the boot node as the target node, and returning to perform the foregoing step S101 until each node in the boot order is triggered.

In another case, the boot node is a node, the trigger condition of which belongs to the second time constraint condition, in the target strategy tree.

In this case, the first operation interface is an editing interface including the first trigger control for the boot node and a plurality of candidate virtual elements. That is, the virtual element corresponding to the boot node is not unique, and the virtual element corresponding to the boot node needs to be determined by an operation performed on the first operation interface.

In this case, a selection operation for any candidate virtual element in the plurality of candidate virtual elements on the first operation interface is received; and in response to a selection operation on the first trigger control, any selected candidate virtual element is determined as the virtual element corresponding to the boot node, so as to perform the predetermined function for the virtual element corresponding to the boot node.

FIG. 10 shows a schematic diagram of a first operation interface provided according to some embodiments of the present disclosure.

As shown in FIG. 10, a candidate virtual element display area is below the first operation interface 10. At least partial candidate virtual elements are displayed in the candidate virtual element display area. When all candidate virtual elements cannot be completely displayed in the candidate virtual element display area, scrolling display may be performed by clicking the rightmost arrow.

When the candidate virtual element 11 is selected, the selected candidate virtual element 11 is displayed in the preview area of the first operation interface 10. If a selection operation for the first trigger control 12 on the first operation interface 10 is received, the candidate virtual element 11 is determined as the virtual element corresponding to the boot node, and the predetermined function is performed on the virtual element corresponding to the boot node.

For example, after the selection operation for the first trigger control 12 on the first operation interface 10 is received, a virtual element confirmation interface is entered. The trigger condition of the virtual element corresponding to the boot node includes a first time constraint and a second time constraint. In this case, a first condition option and a second condition option are displayed in the virtual element confirmation interface, the first condition option is used to indicate the first time constraint condition, and the second condition option is used to indicate the second time constraint condition. When a selection operation of the user on one of the first condition option and the second condition option is received, the selected time constraint condition is determined as the trigger condition of the virtual element, and the predetermined function is performed on the virtual element corresponding to the boot node in the game based on the trigger condition.

FIG. 11 shows a flowchart of a step of triggering a boot node provided according to some embodiments of the present disclosure.

In step S501, a selection operation of a user on a first trigger control is received.

For example, the selection operation may include a click operation on the first trigger control.

In step S502, in response to the selection operation on the first trigger control, a trigger condition corresponding to the boot node is determined.

Here, it may be determined whether the trigger condition corresponding to the boot node belongs to a first time constraint condition or a second time constraint condition.

In step S503, when the trigger condition is satisfied, a predetermined function is performed on the virtual element corresponding to the boot node.

For example, if the trigger condition corresponding to the boot node belongs to the first time constraint condition, in response to the selection operation on the first trigger control, the predetermined function is directly performed on the virtual element corresponding to the boot node in the game. If the trigger condition corresponding to the boot node belongs to the second time constraint condition, in response to the selection operation on the first trigger control, after it is waited for a trigger time corresponding to the second time constraint condition, the predetermined function is performed on the virtual element corresponding to the boot node in the game.

For example, the predetermined function may include, but is not limited to, at least one of the following: unlocking (or activating) a corresponding virtual element in the game, applying (or assembling, or using) a corresponding game element in the game, or improving the attribute parameter of the corresponding game element in the game.

Based on the above interaction processing solution of the embodiments of the present disclosure, the user may be assisted in performing an operation on each node in the strategy tree. That is, the node is only automatically selected, and whether to trigger the node is still determined by the user.

Based on the same application concept, according to the embodiments of the present disclosure, there is further provided an apparatus for interaction processing in a game corresponding to the method provided in the foregoing embodiments. Since the principle of solving problems by the apparatus in the embodiments of the present disclosure is similar to the method for interaction processing in a game in the foregoing embodiments of the present disclosure, the implementation of the apparatus may refer to implementation of the method, and details are not described here again.

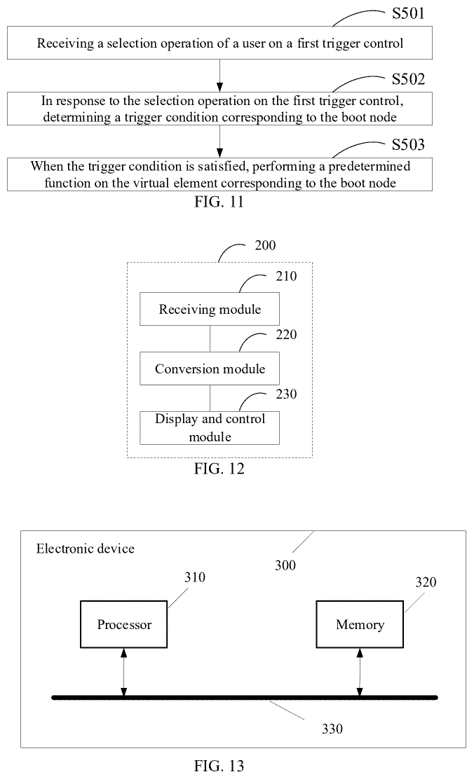

FIG. 12 is a schematic structural diagram of an apparatus for interaction processing in a game according to some embodiments of the present disclosure. As shown in FIG. 12, the apparatus 200 for interaction processing in the game includes a receiving module 210, a conversion module 220 and a display and control module 230.

The receiving module 210 is configured to receive a trigger operation performed by a user on a target node, where the target node is a node in a target strategy tree in the game.

The conversion module 220 is configured to determine a boot node of the target node in response to the trigger operation, and enter a first operation interface corresponding to the boot node.

The display and control module 230 is configured to display a first trigger control for the boot node on the first operation interface, where the first trigger control is configured for performing a predetermined function for a virtual element corresponding to the boot node in the game.

In some embodiments of the present disclosure, the trigger operation includes a selection operation performed by the user on the second trigger control on a second operation interface corresponding to the target node, and the second trigger control is configured for performing a predetermined function for a virtual element corresponding to the target node in the game.

In some embodiments of the present disclosure, the target node is a node in the target strategy tree that satisfies the following conditions: each node on a specified node path in the target strategy tree has been triggered, where the specified node path is a path from a parent node of the target node to a root node of the target node, and a node being triggered refers to that a predetermined function has been performed on a virtual element corresponding to the node in the game; and, a trigger condition corresponding to the target node belongs to a target constraint condition.

In some embodiments of the present disclosure, the display and control module 230 is configured to display a tree structure interface for the target strategy tree, where the target node in the target strategy tree is displayed in the tree structure interface; and the receiving module 210 is configured to enter the second operation interface corresponding to the target node in response to a selection operation performed on the target node on the tree structure interface. In some embodiments of the present disclosure, each node in the target strategy tree is provided with a corresponding constraint condition, and the conversion module 220 is configured to determine the boot node of the target node in the following manner: screening out a first candidate node from nodes of the target strategy tree according to a target constraint condition; determining the boot order based on the first candidate node; and determining the boot node of the target node from the nodes of the target strategy tree based on the boot order, where the boot node is a next node to the target node in a boot order for the target strategy tree.

In some embodiments of the present disclosure, the conversion module 220 determines the boot order based on the first candidate node in the following manner: determining a first sub-order of the first candidate node, and determining the first sub-order as the boot order.

In some embodiments of the present disclosure, the target constraint condition includes a first time constraint condition, and the conversion module 220 determines the first sub-order of the first candidate node in the following manner: determining a traversal order for the target strategy tree according to a preset traversal rule; and, forming the first sub-order corresponding to all first candidate nodes by performing traversal on each first candidate node in the target strategy tree according to the determined traversal order; where the first candidate node is a node, a trigger condition of which belongs to the first time constraint condition, in the target strategy tree.

In some embodiments of the present disclosure, a position of the first candidate node in the boot order is before other nodes.

In some embodiments of the present disclosure, the conversion module 220 determines the boot order based on the first candidate node in the following manner: determining a first sub-order of the first candidate node and a second sub-order of a second candidate node; where the second candidate node is a node, a trigger condition of which belongs to a second time constraint condition, in the target strategy tree; and constructing the boot order according to the first sub-order and the second sub-order, where the second sub-order is after the first sub-order.

In some embodiments of the present disclosure, the target constraint condition includes the second time constraint condition, and the conversion module 220 determines the second sub-order of the second candidate node in the following manner: determining a traversal order for the target strategy tree according to a preset traversal rule; and forming the second sub-order corresponding to all second candidate nodes by performing traversal on each second candidate node in the target strategy tree according to the determined traversal order.

In some embodiments of the present disclosure, the conversion module 220 is configured to enter the first operation interface corresponding to the boot node by automatically selecting the boot node to enter the first operation interface corresponding to the boot node.

In some embodiments of the present disclosure, the conversion module 220 is configured to enter the first operation interface in the following manner: in response to the trigger operation, switch an interface to exit from a second operation interface corresponding to the target node, and display a tree structure interface; and, automatically select the boot node on the displayed tree structure interface to enter the first operation interface corresponding to the boot node.

In some embodiments of the present disclosure, the conversion module 220 is further configured to perform the following processing: after the interface is switched, controlling the tree structure interface to perform movement on a screen to display the boot node in the target strategy tree on the screen; and/or, after the boot node is automatically selected, creating a window, and displaying the first operation interface corresponding to the boot node in the created window.

In some embodiments of the present disclosure, the receiving module 210 is configured to: receive a selection operation performed by the user on the first trigger control; in response to the selection operation on the first trigger control, determine a trigger condition corresponding to the boot node; and when the trigger condition is satisfied, perform the predetermined function for the virtual element corresponding to the boot node.

In some embodiments of the present disclosure, the boot node is a node, a trigger condition of which belongs to a first time constraint condition, in the target strategy tree; and the first operation interface is a simplified interface including the first trigger control for the boot node; where, the conversion module 220 is configured to, in response to a selection operation on the first trigger control, determine a next node to the boot node in the boot order for the target strategy tree, and enter a third operation interface corresponding to the node.

In some embodiments of the present disclosure, the boot node is a node, a trigger condition of which belongs to a second time constraint condition, in the target strategy tree; and the first operation interface is an editing interface including the first trigger control for the boot node and a plurality of candidate virtual elements; where, the receiving module 210 is configured to receive a selection operation for any candidate virtual element in the plurality of candidate virtual elements on the first operation interface. The apparatus further includes a trigger module. The trigger module is configured to, in response to a selection operation on the first trigger control, determine any selected candidate virtual element as the virtual element corresponding to the boot node, to perform the predetermined function for the virtual element corresponding to the boot node.

According to the solution of the embodiments of the present disclosure, frequent operations of the user on each node may be avoided, the operation complexity of the user for each node is reduced, and the interaction efficiency is improved.

Referring to FIG. 13, FIG. 13 is a schematic structural diagram of an electronic device provided according to some embodiments of the present disclosure. As shown in FIG. 13, the electronic device 300 includes a processor 310, a memory 320, and a bus 330.

The memory 320 stores a machine-readable instruction executable by the processor 310. When the electronic device 300 runs, the processor 310 communicates with the memory 320 through the bus 330. When the machine-readable instruction is executed by the processor 310, the steps of the method for interaction processing in a game in any one of the foregoing embodiments may be performed, and the steps are specifically as follows:
receiving a trigger operation performed by a user on a target node, where the target node is a node in a target strategy tree in the game;
determining a boot node of the target node in response to the trigger operation, and entering a first operation interface corresponding to the boot node; and
displaying a first trigger control for the boot node on the first operation interface, where the first trigger control is configured for performing a predetermined function for a virtual element corresponding to the boot node in the game.

In some embodiments of the present disclosure, the trigger operation includes a selection operation performed by the user on a second trigger control on a second operation interface corresponding to the target node, and the second trigger control is configured for performing a predetermined function for a virtual element corresponding to the target node in the game.

In some embodiments of the present disclosure, the target node is a node in the target strategy tree that satisfies following conditions: each node on a specified node path in the target strategy tree has been triggered, where the specified node path is a path from a parent node of the target node to a root node of the target node, and a node being triggered refers to that a predetermined function has been performed on a virtual element corresponding to the node in the game; and, a trigger condition corresponding to the target node belongs to a target constraint condition.

In some embodiments of the present disclosure, the processor 310 is further configured to perform the following processing: displaying a tree structure interface for the target strategy tree, where the target node in the target strategy tree is displayed in the tree structure interface; and entering the second operation interface corresponding to the target node in response to a selection operation performed on the target node on the tree structure interface.

In some embodiments of the present disclosure, each node in the target strategy tree is provided with a corresponding constraint condition, and the processor 310 is further configured to determine the boot node of the target node by performing the following processing: screening out a first candidate node from nodes of the target strategy tree according to a target constraint condition; determining the boot order based on the first candidate node; and determining the boot node of the target node from the nodes of the target strategy tree based on the boot order, where the boot node is a next node to the target node in the boot order for the target strategy tree.

In some embodiments of the present disclosure, the processor 310 is further configured to determine the boot order based on the first candidate node by performing the following processing: determining a first sub-order of the first candidate node, and determining the first sub-order as the boot order.

In some embodiments of the present disclosure, the target constraint condition includes a first time constraint condition, and the processor 310 is further configured to determine the first sub-order of the first candidate node by performing the following processing: determining a traversal order for the target strategy tree according to a preset traversal rule; and, forming the first sub-order corresponding to all first candidate nodes by performing traversal on each first candidate node in the target strategy tree according to the determined traversal order; where the first candidate node is a node, a trigger condition of which belongs to the first time constraint condition, in the target strategy tree.

In some embodiments of the present disclosure, a position of the first candidate node in the boot order is before other nodes.

In some embodiments of the present disclosure, the processor 310 is further configured to determine the boot order based on the first candidate node by performing the following processing: determining a first sub-order of the first candidate node and a second sub-order of a second candidate node; where the second candidate node is a node, a trigger condition of which belongs to a second time constraint condition, in the target strategy tree; and constructing the boot order according to the first sub-order and the second sub-order, where the second sub-order is after the first sub-order.

In some embodiments of the present disclosure, the target constraint condition includes the second time constraint condition, and the processor 310 is further configured to determine the second sub-order of the second candidate node by performing the following processing: determining a traversal order for the target strategy tree according to a preset traversal rule; and, forming the second sub-order corresponding to all second candidate nodes by performing traversal on each second candidate node in the target strategy tree according to the determined traversal order.

In some embodiments of the present disclosure, the processor 310 is further configured to enter a first operation interface corresponding to the boot node by performing the following processing: automatically selecting the boot node to enter the first operation interface corresponding to the boot node.

In some embodiments of the present disclosure, the processor 310 is further configured to enter the first operation interface in the following manner: in response to the trigger operation, switching an interface to exit from a second operation interface corresponding to the target node, and displaying a tree structure interface; and, automatically selecting the boot node on the displayed tree structure interface to enter the first operation interface corresponding to the boot node.

In some embodiments of the present disclosure, the processor 310 is further configured to perform the following processing: after the interface is switched, controlling the tree structure interface to perform movement on a screen to display the boot node in the target strategy tree in the screen; and/or, after the boot node is automatically selected, creating a window, and displaying the first operation interface corresponding to the boot node in the created window. In some embodiments of the present disclosure, the processor 310 is further configured to perform the following processing: receiving a selection operation performed by the user on the first trigger control; in response to a selection operation on the first trigger control, determining a trigger condition corresponding to the boot node; and when the trigger condition is satisfied, performing the predetermined function for the virtual element corresponding to the boot node. In some embodiments of the present disclosure, the boot node is a node, a trigger condition of which belongs to a first time constraint condition, in the target strategy tree; and the first operation interface is a simplified interface including the first trigger control for the boot node; where, the processor 310 is further configured to perform the following processing: in response to a selection operation on the first trigger control, determining a next node to the boot node in the boot order for the target strategy tree, and entering a third operation interface corresponding to the node.

In some embodiments of the present disclosure, the boot node is a node, a trigger condition of which belongs to a second time constraint condition, in the target strategy tree; and the first operation interface is an editing interface including the first trigger control for the boot node and a plurality of candidate virtual elements; where, the processor 310 is further configured to perform the following processing: receiving a selection operation for any candidate virtual element in the plurality of candidate virtual elements on the first operation interface; and, in response to a selection operation on the first trigger control, determining any selected candidate virtual element as the virtual element corresponding to the boot node, to perform the predetermined function for the virtual element corresponding to the boot node.

According to the solution of the embodiments of the present disclosure, frequent operations of the user on each node may be avoided, the operation complexity of the user for each node is reduced, and the interaction efficiency is improved.

According to an embodiment of the present disclosure, there is further provided a computer-readable storage medium. The storage medium stores a computer program. When the computer program is run by the processor, the steps of the method for interaction processing in a game in any one of the foregoing embodiments may be performed, and the steps are specifically as follows.
receiving a trigger operation performed by a user on a target node, where the target node is a node in a target strategy tree in the game;
determining a boot node of the target node in response to the trigger operation, and entering a first operation interface corresponding to the boot node; and
displaying a first trigger control for the boot node on the first operation interface, where the first trigger control is configured for performing a predetermined function for a virtual element corresponding to the boot node in the game.

In some embodiments of the present disclosure, the trigger operation includes a selection operation performed by the user on a second trigger control on a second operation interface corresponding to the target node, and the second trigger control is configured for performing a predetermined function for a virtual element corresponding to the target node in the game.

In some embodiments of the present disclosure, the target node is a node in the target strategy tree that satisfies following conditions: each node on a specified node path in the target strategy tree has been triggered, where the specified node path is a path from a parent node of the target node to a root node of the target node, and a node being triggered refers to that a predetermined function has been performed on a virtual element corresponding to the node in the game; and, a trigger condition corresponding to the target node belongs to a target constraint condition.

In some embodiments of the present disclosure, the processor is further configured to perform the following processing: displaying a tree structure interface for the target strategy tree, where the target node in the target strategy tree is displayed in the tree structure interface; and entering the second operation interface corresponding to the target node in response to a selection operation performed on the target node on the tree structure interface.

In some embodiments of the present disclosure, each node in the target strategy tree is provided with a corresponding constraint condition, and the processor is further configured to determine the boot node of the target node by performing the following processing: screening out a first candidate node from nodes of the target strategy tree according to a target constraint condition; determining the boot order based on the first candidate node; and determining the boot node of the target node from the nodes of the target strategy tree based on the boot order, where the boot node is a next node to the target node in the boot order for the target strategy tree.

In some embodiments of the present disclosure, the processor is further configured to determine the boot order based on the first candidate node by performing the following processing: determining a first sub-order of the first candidate node, and determining the first sub-order as the boot order.

In some embodiments of the present disclosure, the target constraint condition includes a first time constraint condition, and the processor is further configured to determine the first sub-order of the first candidate node by performing the following processing: determining a traversal order for the target strategy tree according to a preset traversal rule; and, forming the first sub-order corresponding to all first candidate nodes by performing traversal on each first candidate node in the target strategy tree according to the determined traversal order; where the first candidate node is a node, a trigger condition of which belongs to the first time constraint condition, in the target strategy tree.

In some embodiments of the present disclosure, a position of the first candidate node in the boot order is before other nodes.

In some embodiments of the present disclosure, the processor is further configured to determine the boot order based on the first candidate node by performing the following processing: determining a first sub-order of the first candidate node and a second sub-order of a second candidate node; where the second candidate node is a node, a trigger condition of which belongs to a second time constraint condition, in the target strategy tree; and constructing the boot order according to the first sub-order and the second sub-order, where the second sub-order is after the first sub-order.

In some embodiments of the present disclosure, the target constraint condition includes the second time constraint condition, and the processor is further configured to determine the second sub-order of the second candidate node by performing the following processing: determining a traversal order for the target strategy tree according to a preset traversal rule; and, forming the second sub-order corresponding to all second candidate nodes by performing traversal on each second candidate node in the target strategy tree according to the determined traversal order.

In some embodiments of the present disclosure, the processor is further configured to enter a first operation interface corresponding to the boot node by performing the following processing: automatically selecting the boot node to enter the first operation interface corresponding to the boot node.

In some embodiments of the present disclosure, the processor is further configured to enter the first operation interface in the following manner: in response to the trigger operation, switching an interface to exit from a second operation interface corresponding to the target node, and displaying a tree structure interface; and, automatically selecting the boot node on the displayed tree structure interface to enter the first operation interface corresponding to the boot node.

In some embodiments of the present disclosure, the processor is further configured to perform the following processing: after the interface is switched, controlling the tree structure interface to perform movement on a screen to display the boot node in the target strategy tree in the screen; and/or, after the boot node is automatically selected, creating a window, and displaying the first operation interface corresponding to the boot node in the created window.

In some embodiments of the present disclosure, the processor is further configured to perform the following processing: receiving a selection operation performed by the user on the first trigger control; in response to a selection operation on the first trigger control, determining a trigger condition corresponding to the boot node; and when the trigger condition is satisfied, performing the predetermined function for the virtual element corresponding to the boot node. In some embodiments of the present disclosure, the boot node is a node, a trigger condition of which belongs to a first time constraint condition, in the target strategy tree; and the first operation interface is a simplified interface including the first trigger control for the boot node; where, the processor is further configured to perform the following processing: in response to a selection operation on the first trigger control, determining a next node to the boot node in the boot order for the target strategy tree, and entering a third operation interface corresponding to the node.

In some embodiments of the present disclosure, the boot node is a node, a trigger condition of which belongs to a second time constraint condition, in the target strategy tree; and the first operation interface is an editing interface including the first trigger control for the boot node and a plurality of candidate virtual elements; where, the processor is further configured to perform the following processing: receiving a selection operation for any candidate virtual element in the plurality of candidate virtual elements on the first operation interface; and, in response to a selection operation on the first trigger control, determining any selected candidate virtual element as the virtual element corresponding to the boot node, to perform the predetermined function for the virtual element corresponding to the boot node.

According to the solution of the embodiments of the present disclosure, frequent operations of the user on each node may be avoided, the operation complexity of the user for each node is reduced, and the interaction efficiency is improved.

It may be clearly understood by those skilled in the art that, for the purpose of convenient and brief description, the detailed working process of the foregoing system and apparatus may refer to a corresponding process in the foregoing method embodiments, which is not described in detail here. In the several embodiments provided in the present disclosure, it should be understood that the disclosed system, apparatus, and method may be implemented in other manners. The apparatus embodiments described above are merely illustrative. For example, division of the units is merely a logical function division, and there may be another division manner in actual implementation. For another example, a plurality of units or components may be combined or may be integrated into another system, or some features may be ignored or not performed. In addition, the displayed or discussed mutual coupling or direct coupling or communication connection may be indirect coupling or communication connection between devices or units through some communication interfaces, and may be in electrical, mechanical, or other forms.

The units described as separate parts may or may not be physically separate. The parts displayed as units may or may not be physical units, and may be located in one position or distributed on a plurality of network units. Some or all of the units may be selected according to actual needs to achieve the objectives of the solutions of the embodiments.

In addition, the various functional units in the embodiments of the present disclosure may be integrated into one processing unit, or each of the units may exist alone physically, or two or more units are integrated into one unit.

When the functions are implemented in the form of a software functional unit and sold or used as an independent product, the functions may be stored in a non-volatile computer-readable storage medium executable by a processor. Based on such understanding, the technical solutions of the present disclosure in essence or a part of the technical solutions that contribute to the related art or a part of the technical solutions may be embodied in the form of a software product. The computer software product is stored in a storage medium, and includes several instructions for causing a computer device (which may be a personal computer, a server, or a network device) to perform all or part of the steps of the methods described in the embodiments of the present disclosure. The foregoing storage medium includes any medium that can store program code, such as a USB flash drive, a removable hard disk, a read-only memory (ROM), a random access memory (RAM), a magnetic disk, or an optical disk.

According to the method for interaction processing in the game, the apparatus, the electronic device and the storage medium provided in the embodiments of the present disclosure, by introducing an automatic boot mechanism, the operation process of the user on each node in the target strategy tree is simplified, thus improving the interaction efficiency; each node is sequentially taken as a target node to trigger an automatic selection mechanism for the boot node, and based on a manner combining automatic boot and manual trigger, not only can the frequent operations of the user on each node be avoided, but also can the omission of the nodes in the target strategy tree be avoided; due to the manner of automatic boot and manual trigger, the interaction experience that the user obtains the virtual element from the game is retained, while reducing the operation complexity of the user for each node, which are conducive to improve the stickiness of the user; the interaction experience breakpoint caused by frequent sliding and clicking of the user may be reduced, thus improving the play smoothness; and, the operation cost and the running duration of the game in the terminal device are further reduced, thus saving the power consumption of the terminal device.

The above are only specific implementations of the present disclosure, but the protection scope of the present disclosure is not limited to this. Any changes or substitutions that can be easily conceived of by those skilled in the art within the technical scope disclosed in the present disclosure, should be covered within the protection scope of the present disclosure. Therefore, the protection scope of the present disclosure shall be subject to the protection scope of the claims.

1. A method for interaction processing in a game, comprising:
receiving a trigger operation performed by a user on a target node, wherein the target node is a node in a target strategy tree in the game;
determining a boot node of the target node in response to the trigger operation, and entering a first operation interface corresponding to the boot node; and
displaying a first trigger control for the boot node on the first operation interface, wherein the first trigger control is configured for performing a predetermined function for a virtual element corresponding to the boot node in the game.

2. The method according to claim 1, wherein the trigger operation comprises a selection operation performed by the user on a second trigger control on a second operation interface corresponding to the target node, and the second trigger control is configured for performing a predetermined function for a virtual element corresponding to the target node in the game.

3. The method according to claim 1, wherein the target node is a node in the target strategy tree that satisfies following conditions:
each node on a specified node path in the target strategy tree has been triggered, wherein the specified node path is a path from a parent node of the target node to a root node of the target node, and a node being triggered refers to that a predetermined function has been performed on a virtual element corresponding to the node in the game; and
a trigger condition corresponding to the target node belongs to a target constraint condition.

4. The method according to claim 2, further comprising:
displaying a tree structure interface for the target strategy tree, wherein the target node in the target strategy tree is displayed in the tree structure interface; and
entering the second operation interface corresponding to the target node in response to a selection operation performed on the target node on the tree structure interface.

5. The method according to claim 1, wherein each node in the target strategy tree is provided with a corresponding constraint condition; and
wherein determining the boot node of the target node comprises:
screening out a first candidate node from nodes of the target strategy tree according to a target constraint condition;
determining the boot order based on the first candidate node; and
determining the boot node of the target node from the nodes of the target strategy tree based on the boot order, wherein the boot node is a next node to the target node in the boot order for the target strategy tree.

6. The method according to claim 5, wherein determining the boot order based on the first candidate node comprises:
determining a first sub-order of the first candidate node; and
determining the first sub-order as the boot order.

7. The method according to claim 6, wherein the target constraint condition comprises a first time constraint condition;
wherein determining the first sub-order of the first candidate node comprises:
determining a traversal order for the target strategy tree according to a preset traversal rule; and
forming the first sub-order corresponding to all first candidate nodes by performing traversal on each first candidate node in the target strategy tree according to the determined traversal order; wherein the first candidate node is a node, a trigger condition of which belongs to the first time constraint condition, in the target strategy tree.

8. The method according to claim 5, wherein a position of the first candidate node in the boot order is before other nodes.

9. The method according to claim 8, wherein determining the boot order based on the first candidate node comprises:
determining a first sub-order of the first candidate node and a second sub-order of a second candidate node; wherein the second candidate node is a node, a trigger condition of which belongs to a second time constraint condition, in the target strategy tree; and
constructing the boot order according to the first sub-order and the second sub-order, wherein the second sub-order is after the first sub-order.

10. The method according to claim 9, wherein the target constraint condition comprises the second time constraint condition; and
determining the second sub-order of the second candidate node comprises:
determining a traversal order for the target strategy tree according to a preset traversal rule; and
forming the second sub-order corresponding to all second candidate nodes by performing traversal on each second candidate node in the target strategy tree according to the determined traversal order.

11. The method according to claim 1, wherein entering the first operation interface corresponding to the boot node comprises:
automatically selecting the boot node to enter the first operation interface corresponding to the boot node.

12. The method according to claim 4, wherein the first operation interface is entered in a following manner:
in response to the trigger operation, switching an interface to exit from a second operation interface corresponding to the target node, and displaying a tree structure interface; and
automatically selecting the boot node on the displayed tree structure interface to enter the first operation interface corresponding to the boot node.

13. The method according to claim 12, further comprising at least one of:
in response to the interface being switched, controlling the tree structure interface to perform movement on a screen to display the boot node in the target strategy tree on the screen; or
in response to the boot node being automatically selected, creating a window, and displaying the first operation interface corresponding to the boot node in the created window.

14. The method according to claim 1, further comprising:
receiving a selection operation performed by the user on the first trigger control;
in response to the selection operation on the first trigger control, determining a trigger condition corresponding to the boot node; and
in response to the trigger condition being satisfied, performing the predetermined function for the virtual element corresponding to the boot node.

15. The method according to claim 1, wherein the boot node is a node, a trigger condition of which belongs to a first time constraint condition, in the target strategy tree; and the first operation interface is a simplified interface comprising the first trigger control for the boot node;
wherein the method further comprises:
in response to a selection operation on the first trigger control, determining a next node to the boot node in the boot order for the target strategy tree, and entering a third operation interface corresponding to the node.

16. The method according to claim 1, wherein the boot node is a node, a trigger condition of which belongs to a second time constraint condition, in the target strategy tree; and
the first operation interface is an editing interface comprising the first trigger control for the boot node and a plurality of candidate virtual elements;
wherein the method further comprises:
receiving a selection operation for any candidate virtual element in the plurality of candidate virtual elements on the first operation interface; and
in response to a selection operation on the first trigger control, determining any selected candidate virtual element as the virtual element corresponding to the boot node, to perform the predetermined function for the virtual element corresponding to the boot node.

17. (canceled)

18. An electronic device, comprising a processor, a storage medium, and a bus, wherein the storage medium stores a machine-readable instruction executable by the processor; and when the electronic device runs, the processor communicates with the storage medium through the bus, and the processor executes the machine-readable instruction to:
receive a trigger operation performed by a user on a target node, wherein the target node is a node in a target strategy tree in the game:
determine a boot node of the target node in response to the trigger operation, and enter a first operation interface corresponding to the boot node; and
display a first trigger control for the boot node on the first operation interface, wherein the first trigger control is configured for performing a predetermined function for a virtual element corresponding to the boot node in the game.

19. A non-transitory computer-readable storage medium, wherein a computer program is stored on the computer-readable storage medium, and when the computer program is run by a processor, a method for interaction processing in a game is performed, and the method comprises:
receiving a trigger operation performed by a user on a target node, wherein the target node is a node in a target strategy tree in the game;
determining a boot node of the target node in response to the trigger operation, and entering a first operation interface corresponding to the boot node; and
displaying a first trigger control for the boot node on the first operation interface, wherein the first trigger control is configured for performing a predetermined function for a virtual element corresponding to the boot node in the game.

20. The electronic device according to claim 18, wherein, the processor is further configured to:
receive a selection operation performed by the user on the first trigger control;
in response to the selection operation on the first trigger control, determine a trigger condition corresponding to the boot node; and
in response to the trigger condition being satisfied, perform the predetermined function for the virtual element corresponding to the boot node.

21. The non-transitory computer-readable storage medium according to claim 19, wherein, the trigger operation comprises a selection operation performed by the user on a second trigger control on a second operation interface corresponding to the target node, and the second trigger control is configured for performing a predetermined function for a virtual element corresponding to the target node in the game.
